(19) United States
(12) Patent Application Publication
(10) Pub. No.: US 2024/0287730 A1
(43) Pub. Date: Aug. 29, 2024

(54) FLUID-FILLED BALANCE RING FOR A WASHING MACHINE

(71) Applicant: Whirlpool Corporation, Benton Harbor, MI (US)

(72) Inventors: Bradley D. Morrow, Stevensville, MI (US); Nicholas C. Fugal, Benton Charter Township, MI (US); Grace Fenech, Buchanan, MI (US)

(73) Assignee: Whirlpool Corporation, Benton Harbor, MI (US)

(21) Appl. No.: 18/113,801

(22) Filed: Feb. 24, 2023

(51) Int. Cl. D06F 37/24; D06F 23/04; D06F 37/12

(52) U.S. Cl. CPC D06F 37/245; D06F 23/04; D06F 37/12; B29C 48/0021; B29C 48/0022; B29C 48/09; B29L 2031/762; F16F 2226/04; F16F 2228/008

(57) ABSTRACT

A washing machine includes a washing machine housing, a wash unit tub, a drum and a first fluid-filled balance ring. The washing machine housing has an opening. The wash unit tub is mounted within the washing machine housing. The drum is rotatable within the wash unit tub. The drum includes a laundry compartment with an open end that is bounded by a rim of the drum. The first fluid-filled balance ring is mounted to the rim of the drum and rotates with the drum to counteract an off-balance load in the laundry compartment of the drum. The first fluid-filled balance ring has a tubular, ring-like shape with a first annular chamber that is sealed and partially filled with a fluid. The fluid in the first annular chamber has a viscosity of at least 90 centipoise.

### FIELD

The present disclosure relates to a fluid-filled balance ring for a washing machine.

### BACKGROUND

This section provides background information related to the present disclosure which is not necessarily prior art.

Washing machines are prolific in both residential and commercial settings. Washing machines are used to clean loads of laundry during a wash cycle of the washing machine. Many washing machines have a top-load configuration, where the washing machine includes a washing machine housing with a top opening that is accessed by a top-mounted door. A wash unit tub is positioned inside the washing machine housing. A drum is positioned in the wash unit tub and is rotatable with respect to the wash unit tub.

The washing machine may become off-balanced when the load of laundry positioned in the drum shifts/collects on one side of the drum and is no longer evenly distributed within the drum. An off-balanced washing machine causes excessive vibrations (e.g., shaking) of the washing machine housing and the generation of an undesirable noise/sound coming from the washing machine. Additionally, in some cases, an off-balanced washing machine may not thoroughly clean the load of laundry, leading to user dissatisfaction.

Some washing machines may include a balance ring that is used to counter the off-balanced load of laundry. However, traditional balance rings include a water filled annular chamber with baffles. Designing and manufacturing traditional balance rings with baffles presents a number of challenges. For example, the geometry of the baffles must be designed to meet various specification for controlling fluid flow, which is time consuming and significantly raises engineering cost during the design process of the washing machine because it is largely a trial and error process that is specific to each model of washing machine. Additionally, sets of baffles are often required to be precisely aligned, which is burdensome during the manufacturing process of the washing machine, because part variability must be avoided. Accordingly, current balance rings are both difficult to design and difficult to manufacture, while adding cost to the washing machine. Solutions that counter-balance an off-balanced washing machine in the face of these challenges are needed.

### SUMMARY

This section provides a general summary of the disclosure, and is not a comprehensive disclosure of its full scope or all of its features.

In accordance with one aspect of the present disclosure, a washing machine is provided that comprises a washing machine housing, a wash unit tub, a drum, and a first fluid-filled balance ring. The washing machine housing has an opening. The wash unit tub is mounted within the washing machine housing. The drum is rotatable within the wash unit tub. The drum includes a laundry compartment with an open end that is bounded by a rim of the drum. The first fluid-filled balance ring is mounted to the rim of the drum and rotates with the drum to counteract an off-balance load in the laundry compartment of the drum. The first fluid-filled balance ring has a tubular, ring-like shape with a first annular chamber that is sealed and partially filled with a fluid. The fluid in the first annular chamber has a viscosity of at least 90 centipoise.

In accordance with another aspect of the present disclosure, the first annular chamber has smooth internal surfaces.

In accordance with another aspect of the present disclosure, the first annular chamber is free of internal ribs, baffles, and fins.

In accordance with another aspect of the present disclosure, the first annular chamber is a single uninterrupted and continuous annular chamber.

In accordance with another aspect of the present disclosure, the washing machine includes a second fluid-filled balance ring that has a tubular, ring-like shape with a second annular chamber that is sealed and partially filled with the fluid.

In accordance with another aspect of the present disclosure, the first annular chamber is an uninterrupted and continuous annular chamber and the second annular chamber is an uninterrupted and continuous annular chamber.

In accordance with another aspect of the present disclosure, the first fluid-filled balance ring is one piece.

In accordance with another aspect of the present disclosure, the first fluid-filled balance ring has a second annular chamber that is sealed and partially filled with fluid.

In accordance with another aspect of the present disclosure, the viscosity of the fluid in the annular chamber is equal to or greater than 90 centipoise and equal to or less than 10,000 centipoise.

In accordance with another aspect of the present disclosure, the viscosity of the fluid in the annular chamber falls within a range of about 500 centipoise to about 4,000 centipoise.

In accordance with another aspect of the present disclosure, the washing machine is a top-load washing machine. The opening of the washing machine is a top opening that is accessed via a washing machine door. The open end of the drum is at a top open end of the drum. The rim of the drum is an upper rim.

In accordance with yet another aspect of the present disclosure, a fluid-filled balance ring for a washing machine is provided that comprises a balance ring body. The balance ring body has a tubular, ring-like shape and a single uninterrupted and continuous annular chamber that is sealed and partially filled with a fluid. The single uninterrupted and continuous annular chamber has smooth internal surfaces. The fluid in the single uninterrupted and continuous annular chamber is free of internal ribs, baffles, and fins and the fluid in the single uninterrupted and continuous annular chamber has a viscosity of at least 90 centipoise.

In accordance with another aspect of the present disclosure, the balance ring body includes an outboard wall, an inboard wall, a top wall, and a bottom wall that cooperate to form the single uninterrupted and continuous annular chamber.

In accordance with another aspect of the present disclosure, a mounting flange extends radially outward from the outboard wall of the balance ring body.

In accordance with another aspect of the present disclosure, the viscosity of the fluid in the single uninterrupted and continuous annular chamber is between about 90 centipoise and about 10,000 centipoise.

In accordance with another aspect of the present disclosure, the viscosity of the fluid in the single uninterrupted and continuous annular chamber falls within a range from 500 centipoise to 4,000 centipoise.

In accordance with another aspect of the present disclosure, the balance ring body includes two cut ends that are joined together to form the single uninterrupted and continuous annular chamber.

In accordance with another aspect of the present disclosure, a method of manufacturing a fluid-filled balance ring for a top-load washing machine is provided. The method comprises a step of extruding a tube. The method comprises a step of making cuts through the tube and forming a circular balance ring body with two cut ends. The method comprises a step of partially filling the tube with a fluid. The method comprises a step of joining the cut ends together to form a balance ring with at least one annular chamber therein.

In accordance with another aspect of the present disclosure, the method further comprises a step of selecting the fluid in the annular chamber to have a viscosity within a range between 90 centipoise to 10,000 centipoise.

In accordance with another aspect of the present disclosure, the method further comprises a step of selecting the fluid in the chamber to have a viscosity within a range of 500 centipoise to 4,000 centipoise.

Advantageously, the balance ring described herein is capable of achieving a success rate for counteracting off-balanced loads of laundry that is comparable to traditional balance rings without the need for complex internal ribs, baffles, and fins. In other words, this design allows the balance ring to efficiently counterbalance an off-balanced load of laundry while eliminating or reducing the number of internal ribs, baffles, or fins in the annular chamber of the balance ring. Thereby, this design eliminates the design and manufacturing challenges of traditional balance rings, while maintaining the performance of the balance ring.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a washing machine constructed in accordance with the present disclosure;

FIG. 2 is a front cross-sectional view of the exemplary washing machine shown in FIG. 1;

FIG. 3 is a side cross-sectional view of an exemplary balance ring of the washing machine shown in FIG. 2;

FIG. 4 is a side cross-sectional view of another exemplary balance ring constructed in accordance with the present disclosure;

FIG. 5 is a side cross-sectional view of another exemplary balance ring constructed in accordance with the present disclosure;

FIG. 6 is a graphical representation of a success rate of four different balance rings;

FIG. 7 is a graphical representation of a success rate of balance rings as a function of fluid viscosity;

FIG. 8 is a flow chart depicting a method of manufacturing a balance ring in accordance with the present disclosure; and

FIG. 9 is a perspective view of an extrusion used to create the balance ring in accordance with the method shown in FIG. 8.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

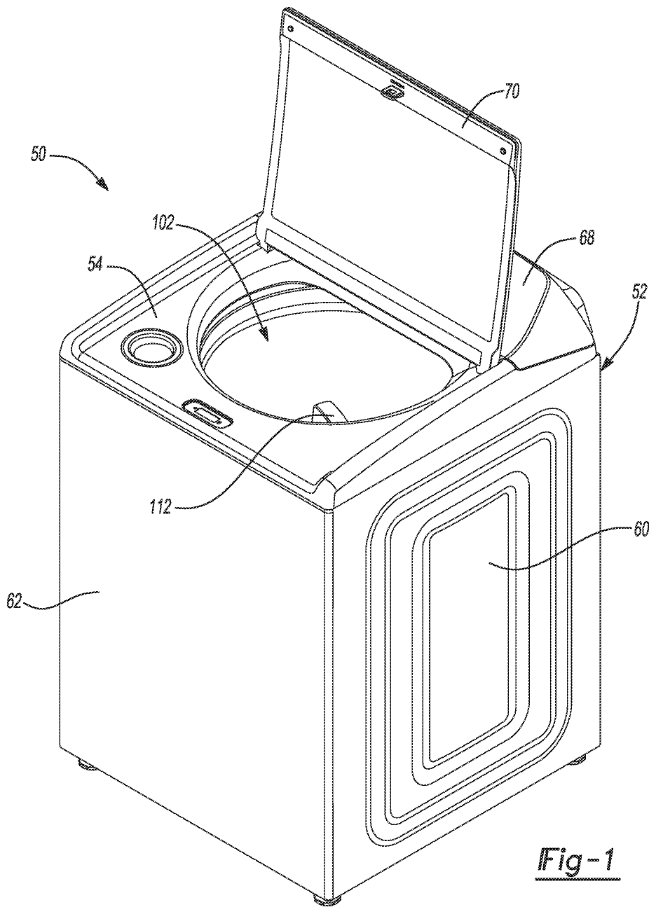

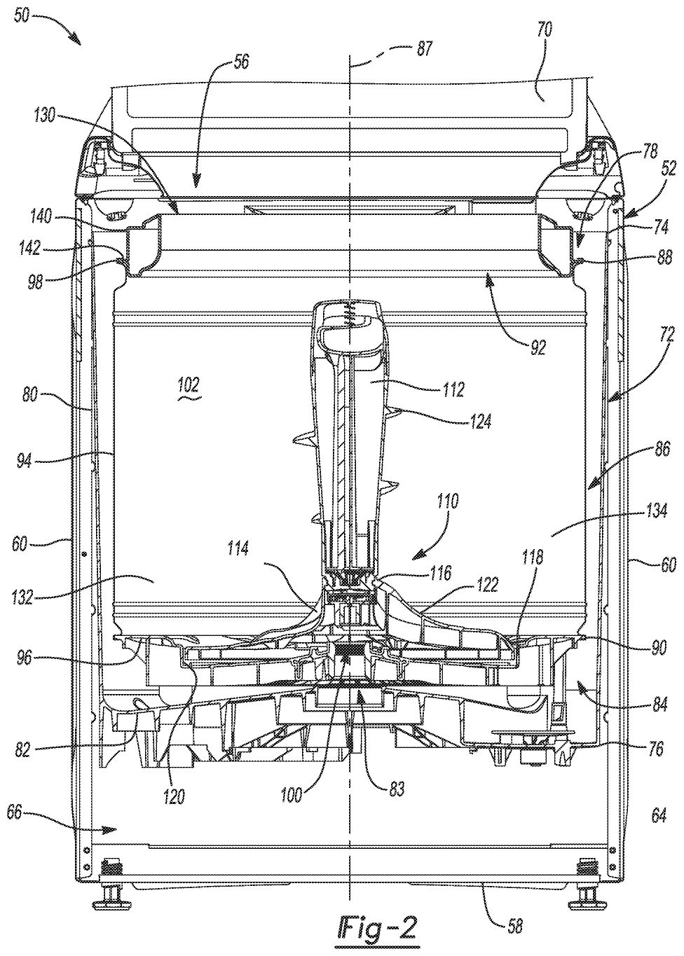

With reference to FIGS. 1 and 2, a washing machine 50 is illustrated in accordance with the present disclosure. The washing machine 50 is illustrated as having a top-load configuration. Alternatively, the washing machine 50 may have a front-load configuration. The washing machine 50 includes a washing machine housing 52. The washing machine housing 52 includes a top housing wall 54 having a housing opening 56, a bottom housing wall 58 opposite to the top housing wall 54, a set of housing sidewalls 60, a front housing wall 62, and a rear housing wall 64. The set of housing sidewalls 60, the front housing wall 62, and the rear housing wall 64 extend between the top housing wall 54 and the bottom housing wall 58. The top housing wall 54, bottom housing wall 58, set of housing sidewalls 60, front housing wall 62, and rear housing wall 64 cooperate to define a housing cavity 66 inside the washing machine housing 52. Although other materials can be used, in the illustrated example, the washing machine housing 52 is composed of metal.

The washing machine 50 may include a control panel 68 that is attached to the top housing wall 54. The control panel 68 is positioned adjacent to the rear housing wall 64. The control panel 68 may include user operated controls (not shown) configured to receive user input of wash settings and a control module (not shown) configured to operate the wash cycle according to the user's input of wash settings. A washing machine door 70 is pivotally connected to the washing machine housing 52, and more specifically, to the top housing wall 54. The washing machine door 70 swings between an open position and a closed position. In the open position shown in FIGS. 1 and 2, the washing machine door 70 provides access to the housing opening 56. In the closed position, the washing machine door 70 closes the housing opening 56. Although other materials can be used, in the illustrated example, the washing machine door 70 is composed of metal.

The washing machine 50 includes a wash unit tub 72 that is mounted inside the housing cavity 66 using one or more suspension elements (not shown). The wash unit tub 72 hangs from the suspension elements, which permit limited degrees of freedom where the wash unit tub 72 can move relative to the washing machine housing 52 during operation of the washing machine 50. The wash unit tub 72 has a substantially cylindrical shape and extends between a top tub end 74 and a bottom tub end 76. The wash unit tub 72 includes a tub opening 78 at the top tub end 74, a tub sidewall 80 that extends between the top tub end 74 and the bottom tub end 76, and a bottom tub wall 82 disposed at the bottom tub end 76. The tub opening 78 is at least partially aligned with the housing opening 56. The bottom tub wall 82 includes a bottom tub opening 83. The tub sidewall 80 and the bottom tub wall 82 define a tub cavity 84 inside the wash unit tub 72.

The washing machine 50 includes a drum 86 that is positioned inside the tub cavity 84. The drum 86 is rotatable with respect to the wash unit tub 72 about an axis 87. The drum 86 has a cylindrical shape and extends between a top drum end 88 and a bottom drum end 90. The drum 86 includes a drum opening 92 at the top drum end 88, a drum sidewall 94 that extends between the top drum end 88 and the bottom drum end 90, and a bottom drum wall 96 disposed that the bottom drum end 90. The drum sidewall 94 curves inward at the at the top drum end 88 and includes an upper rim 98 at the top drum end 88. The bottom drum wall 96 includes a bottom drum opening 100 that is at least partially aligned with the bottom tub opening 83.

The drum sidewall 94 and the bottom drum wall 96 define a laundry compartment 102 inside the drum 86. The housing opening 56, the tub opening 78, and the drum opening 92 are at least partially aligned with one another and therefore provide access to the laundry compartment 102 when the washing machine door 70 is in the open position. In the illustrated example, the housing opening 56, the tub opening 78, and the drum opening 92 are aligned with the axis 87. It should be appreciated that in use, laundry (e.g., clothes, towels, and/or bedding, etc.) is placed inside the laundry compartment 102 where the laundry is cleaned during a wash cycle.

An agitator assembly 110 is positioned inside the laundry compartment 102. The agitator assembly 110 includes an agitator 112 and a base 114. The base 114 extends between a first base end 116 and a second base end 118 that is opposite the first base end 116. The first base end 116 receives the agitator 112. The second base end 118 is disposed within a recess 120 of the bottom drum wall 96. A plurality of fins 122 extends between the first and second base ends 116, 118 and extend in a radially outward direction. Each of the plurality of fins 122 are annularly spaced apart. Each of the plurality of fins 122 are formed in a curved shape. The agitator 112 includes a spiraling fin 124 that extends helically about the agitator 112. The agitator 112 is aligned with the axis 87 and at least partially aligned with the bottom tub opening 83 and the bottom drum opening 100. During the wash cycle, the agitator assembly 110 moves (e.g., rotates) in a clockwise and counter-clockwise direction. For example, the agitator assembly 110 may rotate in a clockwise direction and subsequently in a counter-clockwise direction. The plurality of fins 122 and the spiraling fin 124 thereby contacts and rubs against the laundry placed inside the laundry compartment 102 to aid in cleaning the laundry.

The washing machine 50 may include one or more motor assemblies (not shown). For example, one motor assembly may include a motor and a shaft. The motor may be positioned between the bottom housing wall 58 of the washing machine housing 52 and the bottom tub wall 82 of the wash unit tub 72. The shaft may extend from the motor, through the bottom tub opening 83, through the bottom drum opening 100, and into the agitator 112. The motor assembly may drive rotation of the drum 86 and the agitator assembly 110.

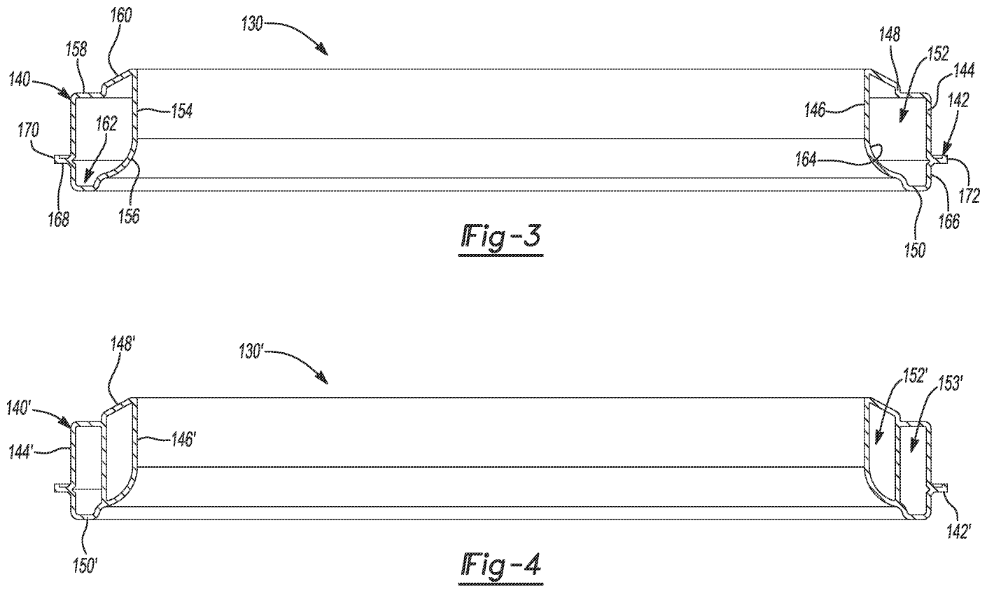

With additional reference to FIG. 3, the washing machine 50 includes a fluid-filled balance ring 130. The laundry positioned within the laundry compartment 102 may be off-balanced, causing undesirable vibrations of the drum 86. For example, more laundry may be positioned on a first side 132 of the laundry compartment 102, as compared to a second side 134 of the laundry compartment 102. The fluid-filled balance ring 130 operates to counteract the off-balanced load and thereby reduces the vibrations caused by the off-balanced load of laundry in the laundry compartment 102. The fluid-filled balance ring 130 is mounted to the rim 98 of the drum 86 and rotates with the drum 86. It should be appreciated that the fluid-filled balance ring 130 may be mounted to another suitable location of the drum 86 and rotates with the drum 86. In one example, the washing machine 50 may include more than one fluid-filled balance 130 that are spaced apart along the axis 87. The fluid-filled balance ring 130 is formed in a tubular, ring-like shape and is partially filled with a fluid. In the illustrated example, the fluid-filled balance ring 130 is one piece. However, the fluid-filled balance ring 130 may be composed of more than one piece.

The fluid-filled balance ring 130 includes a balance ring body 140 and a mounting flange 142. The balance ring body 140 includes an outboard wall 144, an inboard wall 146, a top wall 148, and a bottom wall 150 that cooperate to define an annular chamber 152 therein. In the illustrated example, the outboard wall 144 has a substantially linear cross-sectional shape. The inboard wall 146 includes a first inboard portion 154 and a second inboard portion 156. The first inboard portion 154 is positioned adjacent to the top wall 148 and has a substantially linear cross-sectional shape. The second inboard portion 156 is positioned adjacent to the bottom wall 150 and has a curved cross-sectional shape. The top wall 148 includes a first top portion 158 and a second top portion 160. The first top portion 158 is positioned adjacent to the outboard wall 144 and transversely oriented relative to the outboard wall 144. More specifically, the first top portion 158 is perpendicular relative to the outboard wall 144. The second top portion 160 is raised relative to the first top portion 158 and is positioned adjacent to the inboard wall 146. The second top portion 160 is positioned at an acute angle relative to the inboard wall 146. The bottom wall 150 is substantially parallel with the first top portion 158 of the top wall 148. The bottom wall 150 cooperates with the outboard wall 144 and the second inboard portion 156 of the inboard wall 146 to form a chamber recess 162 in the annular chamber 152. The bottom wall 150 is positioned perpendicular to the outboard wall 144. However, the outboard wall 144, inboard wall 146, top wall 148, and bottom wall 150 may be formed in other shapes.

The fluid-filled balance ring 130 has an internal surface 164 and an external surface 166 that is opposite to the internal surface 164. In the embodiment shown in FIGS. 2 and 3, the internal surface 164 is smooth such that the annular chamber 152 is a single uninterrupted and continuous annular chamber. In other words, in the embodiment shown in FIGS. 2 and 3, the annular chamber 152 is free of internal ribs, baffles and fins. However, it should be appreciated that internal ribs, baffles, and fins could be added to the annular chamber 152 and/or the annular chamber 152 could be divided into two or more annular chambers 152 depending on the characteristics of the fluid in the annular chamber 152.

The mounting flange 142 of the fluid-filled balance ring 130 extends in a radially outward direction. The mounting flange 142 extends between a proximal end 168 that is attached to the outboard wall 144 and a distal end 170 that is opposite the proximal end 168. The mounting flange 142 extends annularly about the balance ring body 140. The distal end 170 of the mounting flange 142 includes a lip 172 that extends in an upward direction. The lip 172 of the mounting flange 142 is received within the rim 98 of the drum 86 in a press-fit arrangement and configured to secure the fluid-filled balance ring 130 to the drum 86. It should be appreciated that another suitable mounting may be used.

The annular chamber 152 of the fluid-filled balance ring 130 is partially filled with the fluid. Examples of the viscosity values associated with various substances are provided in Table 1 to provide a frame of reference. The fluid has a viscosity greater than 1 centipoise (cp) and 1 centistoke (cSt). In other words, the viscosity of the fluid is greater than the viscosity of water. In one example, the fluid may have a viscosity of equal to or more than 90 cp and equal to or less than 10,000 cp. The fluid may also have a density that ranges from about 1 gram per centimeter cubed (g/cm³) to about 3 g/cm³.

TABLE 1
Properties of Fluid

| | Viscosity | Viscosity | Density |
|---|---|---|---|
| Type of Fluid | (centipoise) | (centistokes) | (g/cm³) |
| Water | 1 | 1 | 1.00 |
| Milk | 3 | 3 | 1.00 |
| Cream | 20 | 21 | 1.03 |
| Vegetable Oil | 40 | 43 | 1.08 |
| SAE 10 Oil | 88 | 110 | 1.25 |
| SAE 30 Oil | 352 | 440 | 1.25 |
| Glycerin | 800 | 1,100 | 1.38 |
| Honey | 1,500 | 2,200 | 1.47 |
| Corn Syrup | 2,500 | 3,250 | 1.30 |
| Molasses | 5,000 | 10,800 | 2.16 |
| Sour Cream | 15,000 | 19,000 | 1.27 |
| SAE 70 Oil | 17,640 | 19,600 | 1.11 |
| Window Putty | 100,000 | | |

With reference to FIG. 4, another fluid-filled balance ring 130′ is provided according to the present disclosure. The fluid-filled balance ring 130′ is mounted to the rim 98 of the drum 86 and rotates with the drum 86. The fluid-filled balance ring 130′ is formed in a tubular, ring-like shape and is partially filled with a fluid.

The fluid-filled balance ring 130′ includes a balance ring body 140′ and a mounting flange 142′. The balance ring body 140′ includes an outboard wall 144′, an inboard wall 146′, a top wall 148′, a bottom wall 150′, and a dividing wall 151′. The inboard wall 146′, the top wall 148′, the bottom wall 150′ and the dividing wall 151′ cooperate to define a first annular chamber 152′ therein. The outboard wall 144′, the top wall 148′, the bottom wall 150′ and the dividing wall 151′ cooperate to define a second annular chamber 153′ therein. The second annular chamber 153′ is positioned outboard of the first annular chamber 152′. It should be appreciated that the fluid-filled balance ring 130′ could have any suitable number of annular chambers.

The first annular chamber 152′ and second annular chamber 153′ of the fluid-filled balance ring 130′ are partially filled with the fluid. Examples of the viscosity values associated with various substances are provided in Table 1 above to provide a frame of reference. The fluid has a viscosity greater than 1 centipoise (cp) and 1 centistoke (cSt). In other words, the viscosity of the fluid is greater than the viscosity of water. In one example, the fluid may have a viscosity of equal to or more than 90 cp and equal to or less than 10,000 cp. The fluid may also have a density that ranges from about 1 gram per centimeter cubed (g/cm³) to about 3 g/cm³.

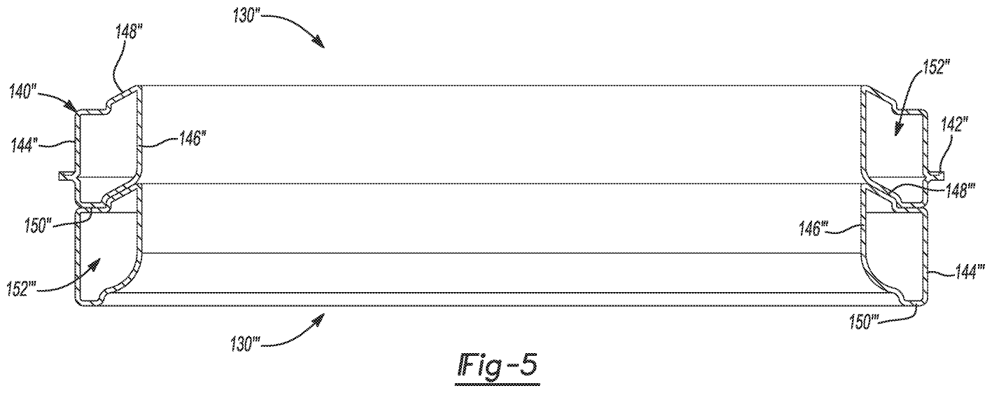

With reference to FIG. 5, a first fluid-filled balance ring 130″ and a second fluid-filled balance ring 130′″ is provided in accordance with the present disclosure. The first fluid-filled balance ring 130″ is mounted to the rim 98 of the drum 86 and rotates with the drum 86. The second fluid-filled balance ring 130′″ is attached to the first fluid-filled balance ring 130″.

The first fluid-filled balance ring 130″ includes a first balance ring body 140″ and a mounting flange 142″. The first balance ring body 140″ includes an outboard wall 144″, an inboard wall 146″, a top wall 148″, and a bottom wall 150″. The outboard wall 144″, the inboard wall 146″, the top wall 148″ and the bottom wall 150″ cooperate to define a first annular chamber 152″ therein. It should be appreciated that the first fluid-filled balance ring 130″ could have any suitable number of annular chambers.

The second fluid-filled balance ring 130′″ includes an outboard wall 144′″, an inboard wall 146′″, a top wall 148′″, and a bottom wall 150′″. The top wall 148′″ of the second fluid-filled balance ring 130′″ attaches to the bottom wall 150′″ of the first fluid-filled balance ring 130″. The outboard wall 144′″, the inboard wall 146′″, the top wall 148′″ and the bottom wall 150′″ cooperate to define a second annular chamber 152′″ therein. It should be appreciated that the second fluid-filled balance ring 130′″ could have any suitable number of annular chambers.

The first and second annular chamber 152″, 152′″ of the first and second fluid-filled balance ring 130″, 130′″ is partially filled with a fluid. Examples of the viscosity values associated with various substances are provided in Table 1 above to provide a frame of reference. The fluid has a viscosity greater than 1 centipoise (cp) and 1 centistoke (cSt). In other words, the viscosity of the fluid is greater than the viscosity of water. In one example, the fluid may have a viscosity of equal to or more than 90 cp and equal to or less than 10,000 cp. The fluid may also have a density that ranges from about 1 gram per centimeter cubed (g/cm³) to about 3 g/cm³.

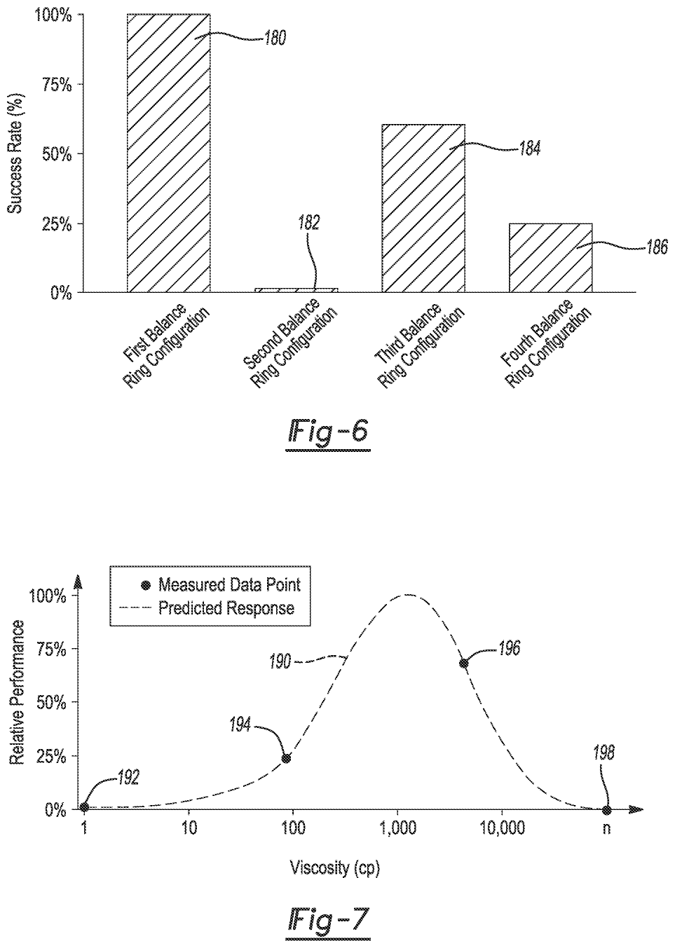

FIG. 6 illustrates a success rate of four fluid-filled balance ring configurations. 72 trials of testing were conducted for each of the four fluid-filled balance ring configurations. In each trial, a load of laundry was off-balanced within a laundry compartment of a washing machine. More specifically, the load of laundry is simulated by using weights that represent the off-balanced load of laundry. The performance of the fluid-filled balance ring to counteract the off-balanced load of laundry was monitored. A successful trial is when the fluid-filled balance ring is able to counteract the off-balanced load of laundry and thereby, the washing machine completes the wash cycle. An unsuccessful trial is when the fluid-filled balance ring was not able to adequately counteract the off-balanced load of laundry, and thereby, the wash cycle is interrupted. The success rate is the percent of successful trials out of the total 72 trials.

In FIG. 6, fluid-filled balance rings with baffles are compared against fluid-filled balance rings without internal ribs, baffles and fins. A first bar 180 represents a success rate for a first fluid-filled balance ring configuration. The first fluid-filled balance ring configuration is formed as a tubular ring having a first annular chamber. The first fluid-filled balance ring configuration includes first baffles disposed within the first annular chamber. The first annular chamber is partially filled with a first fluid having a viscosity of 1 cp (e.g., water). The first baffles are tuned for this fluid. Examples of turning include modifying the geometry of first baffles and the positioning of the first baffles within the first annular chamber. As shown, the success rate for the first fluid-filled balance ring is about 100 percent.

A second bar 182 represents the success rate for a second fluid-filled balance ring configuration. The second fluid-filled balance ring configuration is formed as a tubular ring having a second annular chamber. The second fluid-filled balance ring configuration includes second baffles disposed within the second annular chamber. The second annular chamber is partially filled with a second fluid having a viscosity of 4,000 cp. However, the second baffles are tuned for fluids having the viscosity of only 1 cp. As shown, the success rate for the second balance fluid-filled ring configuration is about 0 percent.

Comparing the test results for the first and second fluid-filled balance rings, it becomes apparent that baffles must be tuned to match the viscosity of the fluid that is in the annular chamber.

The third and fourth fluid-filled balance ring configurations shown in FIG. 4 are free of internal ribs, baffles and fins such that each of the third and fourth fluid-filled balance ring configurations have a single uninterrupted and continuous annular chamber. The third and fourth fluid-filled balance ring configurations are substantially similar to the fluid-filled balance ring 130, as shown in FIGS. 2 and 3. A third bar 184 represents the success rate for the third fluid-filled balance ring configuration and a fourth bar 186 represents the success rate for the fourth fluid-filled balance ring configuration. The annular chamber of the third fluid-filled balance ring configuration is partially filled with a third fluid having a viscosity of 4,000 cp. The annular chamber of the fourth fluid-filled balance ring configuration is partially filled with a fourth fluid having a viscosity of 90 cp. As shown, the success rate of the third fluid-filled balance ring configuration is between 50% and 75% and the success rate of the fourth fluid-filled balance ring is about 25%.

With additional reference to FIG. 7, a performance curve 190 of fluid-filled balance ring configurations prepared in accordance with the present disclosure is illustrated. The performance curve 190 represents a relative performance for fluid-filled balance rings that are free of internal ribs, baffles and fins as a function of viscosity of fluid that is filled in the respective annular chamber. The performance is measured relative to the first balance ring configuration described above in reference to FIG. 4 (i.e., includes first baffles disposed within the first annular chamber; the first annular chamber is partially filled with a first fluid having a viscosity of 1 cp; and the first baffles are tuned for this fluid). A first measured point 192 illustrates that a fluid-filled balance ring partially filled with a fluid having a 1 cp viscosity performs at an about 0% relative performance. A second measured point 194 illustrates that a fluid-filled balance ring partially filled with a fluid having a 90 cp viscosity performs at an about 25% relative performance. A third measured point 196 illustrates that a fluid-filled balance ring partially filled with a fluid having a 4,000 cp viscosity performs at a relative performance between 50% and 75%. A fourth measured point 198 illustrates that a fluid-filled balance ring partially filled with a fluid having a viscosity of a number n performs at an about 0% relative performance, where n is significantly greater than 4,000. As shown, the success rate has a quadradic relationship with respect to the viscosity of fluid.

Using the performance curve 190, there is an optimized viscosity between 90 and 4,000 cp for a fluid-filled balance ring that is free of internal ribs, baffles, and fins. Therefore, a fluid-filled balance ring free of internal ribs, baffles, and fins is capable of achieving a similar performance, as compared to a fluid-filled balance ring having internal baffles that are tuned to match the viscosity of fluid filled in the annular chamber.

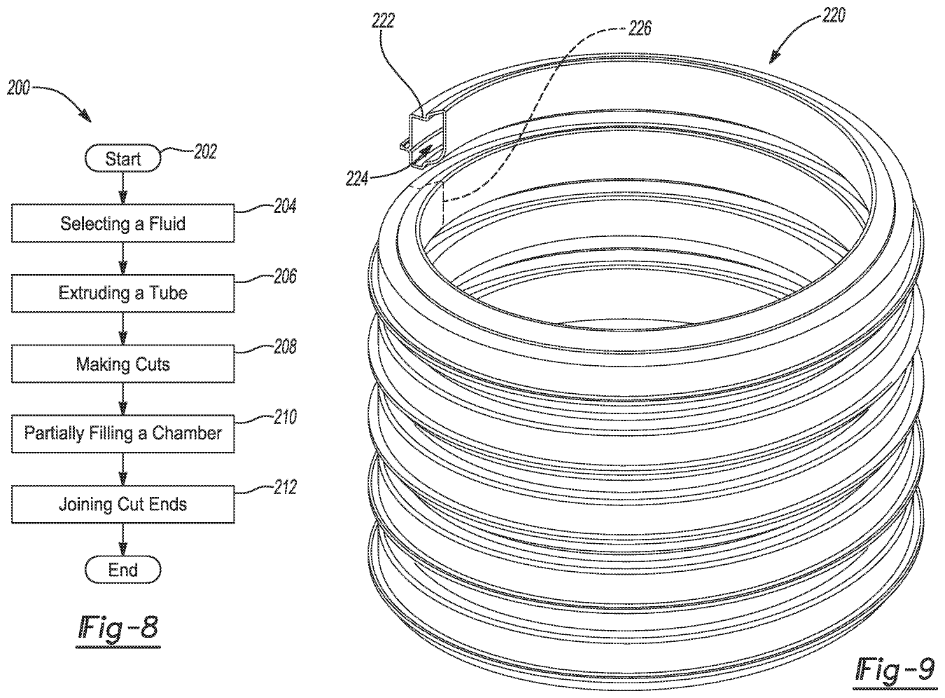

Referring to FIG. 8, a method 200 of manufacturing the fluid-filled balance ring 130 is shown. The method starts at step 202. At step 204, the method 200 proceeds with selecting a fluid. At step 206, the method 200 proceeds with extruding a tube. At step 208, the method 200 proceeds with making cuts through the tube. At step 210, the method 200 continues with partially filling the single uninterrupted and continuous annular chamber with the fluid. At step 212, the method 200 continues with joining the cut ends together to form a continuous and uninterrupted hollow fluid-filled balance ring with a single uninterrupted and continuous annular chamber therein.

An exemplary tube 220 is shown in FIG. 9. Using the method 200, the fluid is selected at step 204. In one example, any fluid having a viscosity of about 90 cp to about 10,000 cp may be selected. In another example, any fluid having a viscosity of about 500 cp to about 4,000 cp may be selected. In some configurations of method 200, the fluid may be selected before step 208, or step 210.

At step 206, the tube 220 is extruded in a spiral shape. In the illustrated example, the tube 220 has five spirals and is therefore capable of forming five fluid-filled balance rings. However, the tube 220 may include any suitable number of spirals and may be capable for forming any suitable number of fluid-filled balance rings as part of a continuous manufacturing process. At step 208, a cut 226 is made radially at each 360-degree loop. For example, the cut 226 is made at 360 degrees from end 222 of the tube 220. The cut 226 may be made using a saw, or any other suitable form of machinery or tool.

It should be appreciated that the tube 220 may be formed in another suitable shape. In one example, the tube 220 is extruded in a linear shape that extends between a first tube end and a second tube end. A cut 226 is made at a selected distance away from the first tube end and repeatedly made to divide the tube 220 into a plurality of tubes.

At step 210, the fluid is partially filled within the annular chamber 224 of the tube 220.

At step 212, the cut 226 and the end 222 are joined together to form a continuous and uninterrupted hollow fluid-filled balance ring with a single uninterrupted and continuous annular chamber 224. In one example, a process of welding the cut 226 and the end 222 may be used to join the ends 222, 226 together. In some configurations of method 200, the fluid may be partially filled within the annular chamber 224 after the cut 226 and the end 222 are joined together.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A washing machine, comprising:
a washing machine housing with an opening;
a wash unit tub mounted within the washing machine housing;
a drum that is rotatable within the wash unit tub, the drum including a laundry compartment with an open end that is bounded by a rim of the drum; and
a first fluid-filled balance ring that is mounted to the rim of the drum and rotates with the drum to counteract an off-balance load in the laundry compartment of the drum,
wherein the first fluid-filled balance ring has a tubular, ring-like shape with a first annular chamber that is sealed and partially filled with a fluid, and
wherein the fluid in the first annular chamber has a viscosity of at least 90 centipoise.

2. The washing machine of claim 1, wherein the first annular chamber has smooth internal surfaces.

3. The washing machine of claim 2, wherein the first annular chamber is free of internal ribs, baffles, and fins.

4. The washing machine of claim 3, wherein the first annular chamber is a single uninterrupted and continuous annular chamber.

5. The washing machine of claim 1, further comprising:
a second fluid-filled balance ring that has a tubular, ring-like shape with a second annular chamber that is sealed and partially filled with the fluid.

6. The washing machine of claim 5, wherein the first annular chamber is an uninterrupted and continuous annular chamber and the second annular chamber is an uninterrupted and continuous annular chamber.

7. The washing machine of claim 1, wherein the first fluid-filled balance ring is one piece.

8. The washing machine of claim 1, wherein the first fluid-filled balance ring has a second annular chamber that is sealed and partially filled with the fluid.

9. The washing machine of claim 1, wherein the viscosity of the fluid in the first annular chamber is less than 10,000 centipoise.

10. The washing machine of claim 1, wherein the viscosity of the fluid in the annular chamber ranges from 500 centipoise to 4,000 centipoise.

11. The washing machine of claim 1, wherein:
the washing machine is a top-load washing machine;
the opening of the washing machine housing is a top opening that is accessed via a washing machine door;
the open end of the drum is at a top end of the drum; and
the rim of the drum is an upper rim.

12. A fluid-filled balance ring for a washing machine, comprising:
a balance ring body with a tubular, ring-like shape and a single uninterrupted and continuous annular chamber that is sealed and partially filled with a fluid,
wherein the single uninterrupted and continuous annular chamber has smooth internal surfaces and is free of internal ribs, baffles, and fins, and
wherein the fluid in the single uninterrupted and continuous annular chamber has a viscosity of at least 90 centipoise.

13. The fluid-filled balance ring of claim 12, wherein the balance ring body includes an outboard wall, an inboard wall, a top wall, and a bottom wall that cooperate to form the single uninterrupted and continuous annular chamber.

14. The fluid-filled balance ring of claim 13, further comprising:
a mounting flange that extends radially outward from the outboard wall of the balance ring body.

15. The fluid-filled balance ring of claim 12, wherein the viscosity of the fluid in the single uninterrupted and continuous annular chamber is less than 10,000 centipoise.

16. The fluid-filled balance ring of claim 12, wherein the viscosity of the fluid in the single uninterrupted and continuous annular chamber ranges from 500 centipoise to 4,000 centipoise.

17. The fluid-filled balance ring of claim 12, wherein the balance ring body includes two cut ends that are joined together to form the single uninterrupted and continuous annular chamber.

18. A method of manufacturing a fluid-filled balance ring for a washing machine, the method comprising the steps of:
extruding a tube;
making cuts through the tube and forming a circular balance ring body with two cut ends;
partially filling the tube with a fluid; and
joining the cut ends together to form a balance ring with at least one annular chamber therein.

19. The method of claim 18, further comprising the step of:
selecting the fluid in the annular chamber to have a viscosity within a range of 90 centipoise to 10,000 centipoise.

20. The method of claim 18, further comprising the step of:
selecting the fluid in the annular chamber to have a viscosity within a range of 500 centipoise to 4,000 centipoise.
